(19) United States
(12) Patent Application Publication
(10) Pub. No.: US 2024/0315487 A1
(43) Pub. Date: Sep. 26, 2024

(54) Coffee grinder with control of the ground coffee quantity dispensed in each dose

(71) Applicant: CMA Macchine per Caffè S.r.l., Susegana (TV) (IT)

(72) Inventor: Daniele Colizza, Casarile (MI) (IT)

(21) Appl. No.: 18/579,488

(22) PCT Filed: Jul. 25, 2022
(86) PCT No.: PCT/IB2022/056828

§ 371 Date: Jan. 15, 2024

(30) Foreign Application Priority Data
Jul. 28, 2021 (IT) 102021000020201

(51) Int. Cl. A47J 42/44; A47J 42/40

(52) U.S. Cl. CPC A47J 42/44; A47J 42/40

(57) ABSTRACT

A coffee grinder with an electric motor has a control of the amount of dispensed coffee for each dose of ground coffee. Such control is achieved by providing a calibration step and operating alternately according to a first mode of adjusting the period of activation of the electric motor, in which the calibration step is carried out by having the operator vary manually the period of activation of the electric motor, or a second mode of adjusting the period of activation of the electric motor by carrying out the calibration step automatically by comparing the desired weight of ground coffee and the weight of ground coffee that is actually dispensed into the filter holder, and by measuring with a scale or other weighing device that is physically disconnected from the grinder.

### FIELD OF THE INVENTION

The present invention relates to a coffee grinder capable of precisely regulating the quantity of coffee ground from time to time. In particular, the invention is directed to a machine of this type wherein the control of the quantity of ground coffee is performed on the single dosage, comprising an electronic control unit capable of precisely regulating the activity time of an electric motor which controls a grinder unit dedicated to the pulverization of coffee beans and able to precisely calibrate the dose based on the information of the weight actually dispensed found after the production of a dose.

### PRIOR ART

The coffee shop market has for long required coffee grinders capable of grinding coffee beans at the time of consumption, so as to be able to take advantage of the full release of aromas during the preparation of coffee, in particular the so-called espresso coffee. As it is well known, in fact, ground coffee powder allows greater contact with boiling water and therefore a better and more complete extraction of the various components; however, the coffee powder quickly loses its taste and aromas, so it is advisable that coffee beans are ground only shortly before use. The grinding performed “on the spot”, i.e. immediately before the preparation of the coffee, is a crucial step wherein the granulometry of the powder obtained and its homogeneity are determining factors for the success of all subsequent operations, in order to transfer to the best possible measure the properties of the coffee bean in an espresso cup.

In order to respond to this need-initially felt in the gourmet type coffee shop field, and then quickly shared by the whole coffee world-technological progress has allowed to sell innovative coffee grinders on the market capable of not only making a micrometric adjustment of the desired granulometry of the ground coffee, but also to guarantee the delivery of the same quantity over time, hereinafter also referred to as “dose”, of the same. In fact, since the granulometric profile of ground coffee powder is greatly influenced by external environmental such in variables, as particular humidity and temperature, it was necessary to prepare real-time control systems in the preparation of the ground coffee dose, so as to be able to offer consumers an espresso coffee having perfectly constant organoleptic characteristics despite the continuous variability of said environmental conditions.

The market has thus pushed towards the production of coffee grinders that are able to deliver doses of coffee exactly of the desired weight, for example single doses of 7 grams, with the highest possible precision, managing in the most appropriate way the variables that occur in the grinding process and problems due to variations in environmental working conditions, such as temperature and humidity, as well as the type and degree of drying of the coffee blend used and other similar variables.

The salient features of the documents most representative of the most recent state of the art of coffee grinders are briefly commented below.

EP2694216 (February 2014) describes a coffee grinder machine which comprises a weighing system for the dose of coffee dispensed on the basket of the filter holder, whose support fork is directly connected to a load cell, arranged inside the structure of the machine.

EP3019057 (May 2016) describes a coffee grinder machine with a weighing system similar to that described in the previous patent, wherein a support system is provided for the filter holder which allows to safeguard the limiting stroke elements of the load cell in case of application of high external forces, thus also allowing the settling function of the ground coffee in the filter by pushing it against the surface of the device.

EP3158902 (April 2017) describes a coffee grinder machine that proposes a leverage system between the fork of the filter holder and the load cell. Said leverage system includes a means of limiting the stroke of the free end of the load cell to protect the weighing device in the presence of overloads.

EP3167782 (May 2017) describes a coffee grinder machine that calibrates continuously during the normal operation of the machine, every time a predetermined number of weighs of the different types has been reached. The calibration system then substantially follows the same procedure described in the previous patent EP3097831, in the name of the same owner, commented above.

However, the known systems described above have drawbacks intrinsically connected to the selected indirect calculation method, which do not allow to achieve a satisfactory precision result in calculating the weight of the dose of ground coffee.

A first solution to improve the precision of the quantity of ground coffee produced for each dose was found by the applicant with application number 102018000009926 wherein the coffee grinder is provided with a load cell for the direct weighing of the ground coffee that is poured into the filter holder during grinding, combined with an electronic control unit capable of processing the weight of the ground coffee in real time and making corrections to the activation time of the grinders in order to minimize the difference between the target weight, i.e. the weight that the user wishes to obtain the weight in the filter holder at the end of the single activation of the coffee grinder, and the weight actually obtained.

Document 102018000009926 therefore teaches how to make a coffee grinder with a weighing system present into the machine body, which weighing system is used iteratively to inform an electronic control unit that performs software steps for intelligent regulation of the electric motor according to the weight instantly detected during filling the filter holder.

In addition to this development, the Applicant has also worked in order to further improve the coffee grinders of the type initially shown, i.e. those that work by indirectly detecting the weight of the ground coffee, in order to differentiate the commercial offer with respect to products as per document the 102018000009926, with a constructively simple and compact coffee grinder, designed not to have a load cell or other weighing device which obviously must have specific characteristics to accurately detect (tenths of a gram) contained quantities of product contained in a heavy filter holder several hundred of grams, said weighing device having also to operate in the context of high vibrations resulting from the activity of the grinders.

Therefore, is felt the need to create a coffee grinder that improves the quantitative precision of the dose of ground coffee without adopting a direct weighing system, reaching a degree of precision and consistency of the weight of the ground dose higher than that offered by the coffee grinders currently present on the market. It is in fact very complex to calibrate a correct dose of coffee since to obtain a pleasant aroma it is necessary to act both on the granulometry and on the quantity of ground coffee, until the desired taste is obtained. Therefore, the bar waiters must continuously act on the adjustment of the grinders and make continuous calculations regarding the delivery times of the ground coffee. Furthermore, a correct dose allows to optimize the cost of the raw material for each cup served.

In this regard, the Applicant has in fact first of all found, in the studies and experiments performed, that in the initial transitional period of the grinding the effective grinding speed differs considerably from the average grinding speed calculated during the calibration of the machine as a function of random errors related to the duration of the start-up transient, the conformation of the grinders, the arrangement of the coffee beans above the grinders and those already partially inserted between them and finally the specific starting position of the grinders thus determining not negligible inhomogeneities in the effective weight of the dose ground, even with the same grinding time. Similarly to the start-up transient, a quantity of coffee that is considerably different from that generated in the steady step is also produced during the stopping step, with times and quantities dispensed that can also vary according to the granulometry of the powders and the types of coffee and the configuration of the grinders, which can be adjusted by the operator in order to vary the consistency of what is deposited in the filter holder.

### DESCRIPTION OF THE INVENTION

This problem is solved and these scopes are reached by means of a coffee grinder having the features defined in the attached claim 1. Other preferred features of the coffee grinder of the invention are defined in dependent claims.

In accordance with the invention, the coffee grinder can operate according to the known technology, that is with a manual calibration process of the activation time of the machines, or in an innovative way wherein the microprocessor makes the precise calculation of the times according to the grammar detected by the weighing operations operated by means of an external weighing machine. Advantageously, this avoids the operator a long calibration procedure of the duration of the motor activation period, saving time and avoiding waste of powder in an attempt to reach the desired dose. It is the microprocessor that calculates the period of operation of the motor according to one or more weighing of the dose of ground coffee, weighing value that the operator must insert into a system having performed a weighing through a common weighing machine for coffee shop.

The invention therefore aims to reduce below a predetermined threshold the difference between the desired weight and the weight that actually goes in the filter holder after being ground. Such deviation value can be set and is found in a range of values of the order of tenths or hundredths of a gram, preferably not exceeding 0.1 grams.

In one embodiment, the ground coffee comprises at least a mechanism for adjusting the configuration of said group of grinders in order to vary the granulometry of the ground coffee, to which adjusting mechanism of grinders is associated at least one position and/or status sensor of said group of grinders. The adjustment of the position of the grinders is preferably performed by means of a manual mechanism and the relative displacement is measured by a potentiometer or by an optical sensor, which are connected to the microprocessor of the coffee grinder. The variation of the position of the grinders, and therefore of the mass flow rate in grams per minute dispensed, entails the need to perform a new calibration in order to maintain the target doses. The user will then be informed and will be able to choose to start the calibration process.

The optical or potentiometric sensors allow precision in determining the distance of the grinders and consequent granulometry control (5/10 nanometers in the case of the optical sensor). This is important for the repetition of recipes wherein quantity and granulometry must be precisely respected but also because the bar waiter can configure the coffee grinder to obtain the desired aromatic bouquet. The use of high-precision sensors is particularly advantageous in the combination with the other forms of the present invention wherein the weight of the required dose is precisely determined, creating synergy between the precision adjustment of the grinders and the precision determination of the quantity of coffee that same grinders pulverize. Advantageously, the presence of position/status sensors allows the operator to indicate, preferably on a graphic display, in which granulometry range one is, for example:
Less than 200 microns Turkish coffee,
between 250 microns and 400 microns espresso coffee,
from 400 microns to 800 microns moka, above 800 microns filter coffee.

In a further executive variant, in order to further improve the precision of the quantity of coffee in a dose, it is possible to set the calibration also on the average of a certain number of weighs e.g. 2 or 3 weighs. In this variant, the control firmware of the microprocessor also provides a weighted calibration program which includes the following operating steps:
storing a predetermined number (n) of subsequent weighs;
calculating the average weight value on said number (n) of subsequent weighs;
determining the average difference between said average weight value and the target value (Pf) of the desired weight;
modifying at least one operating parameter of the electric motor in the regime state operating step as a function of said average deviation.

This variant is advantageously used in the presence of little homogeneous batches of coffee, both mono-origin and blended.

A further embodiment of the microprocessor also provides a transient calibration program aimed at determining the quantity of coffee powder produced during the said start and/or stop steps, which transient calibration program includes the following operating steps:
informing an operator of the coffee grinder to perform the empty weighing of the filter holder;
acquiring the value of said empty weight of the filter holder;
performing a start and stop step sequentially and possibly repeating such sequence one or more times;
informing an operator of the coffee grinder to perform a weighing on the filter holder once the grinding of a dose is terminated;
acquiring the value of said weighing by the filter holder;
determining the weight of the dose of ground coffee by difference or by the average difference of the previously acquired values;
resetting the quantity of ground coffee associated with said start and stop steps.

In a further executive variant, the microprocessor manages and stores different types of deliveries e.g. single dose, double dose, naked dose (for naked filter holder or without bottom for collecting and conveying leachate coffee) and free dose. Advantageously, the weight calibration procedure, combined with storage in a memory area of the microprocessor, can therefore be combined with different quantities of coffee produced according to the choices of the operator, which does not have to recalibrate each time the required dose changes.

In a further embodiment variant, the microprocessor allows the management of a further overdosed dose, that is a quantity of coffee double compared to the content normally destined to a specific filter holder for single delivery. In this case, having to manage very high doses of powder that would normally tend to flow out from the filter holder basket, the overdosed mode in a first time delivers half the required quantity, allows the bar waiter to act on the powder and then delivering the remaining quantity.

In an executive variant, the microprocessor has an internal counter with total and partial quantities dispensed, also divided by type of dose. This, combined with the precision of the quantity of coffee dispensed, allows the precise determination of the amount of coffee consumed in a given period which, in addition to statistical purposes, can be advantageously used in the case of commercial sales packages for consumption of the raw material wherein is it desired to find out the quantities purchased and processed.

In a further executive variant, the microprocessor suggests when to clean the grinders and replace them.

In further executive variants, the coffee grinder has a removable filter holder arm, secured with magnets, in order to be immediately converted from an espresso grinder to a coffee grinder for filter coffee/groceries or moka and allowing to place on the base bags for the ground or coffee various nature filters. The support structure of the filter holder is therefore easily replaceable in order to adapt to different types of filter holders or other powdered coffee containers. Advantageously, the presence of magnets allows to easily and quickly remove terminal part of the arm both to replace it with one of a different conformation, and to facilitate cleaning operations. However, the presence of the magnets is not to be considered as limiting the embodiment in question, as other restraint systems such as mechanical quick coupling and release systems fall within the more general inventive concept of a filter holder support that is composed of several parts of which at least one that can be removed for use and without the need for specific general equipment or particular technical and/or operational skills. These variants can also be combined with the executive embodiments of checking the weight and semi-automatic calibration of the quantities of coffee for a specific type of filter holder.

Finally, further variants can be provided, that can be achieved in combinations or sub-combinations of the previous ones, wherein the microprocessor allows the user to memorize recipes wherein specific quantities of doses in grams and distances between the grinders can be saved: for example the recipe for “Panama single origin” espresso, double dose 18.2 grams at 220 microns.

### BRIEF DESCRIPTION OF THE DRAWINGS

Further features and advantages of the coffee grinder according to the present invention will in any case become better evident from the following detailed description of a preferred embodiment thereof, provided purely by way of non-limiting example and illustrated in the attached drawings, wherein:

FIGS. 1 and 2 are perspective views of a possible embodiment of the coffee grinder according to the invention;

FIG. 3 is a sectional view of the coffee grinder of FIG. 1;

FIG. 4 is a block diagram representing a generic coffee grinder in relation to a generic weighing device;

FIG. 5 is a flow chart representing the operations of activation of the grinders and correction of this activation period according to the quantity actually found.

### DETAILED DESCRIPTION OF THE PREFERRED EXECUTIVE EMBODIMENT

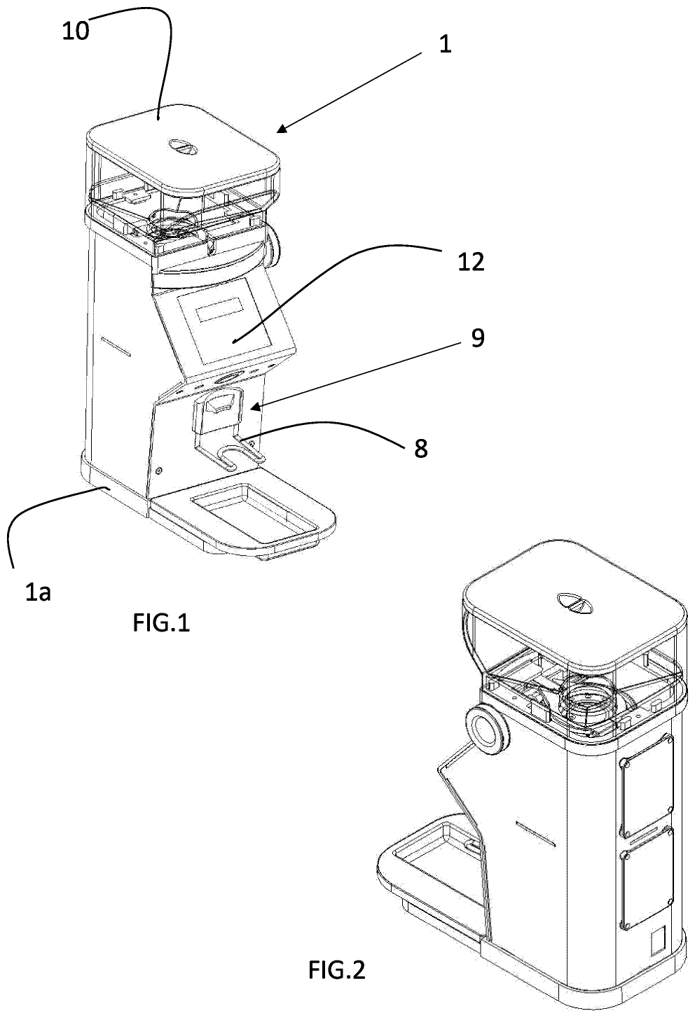

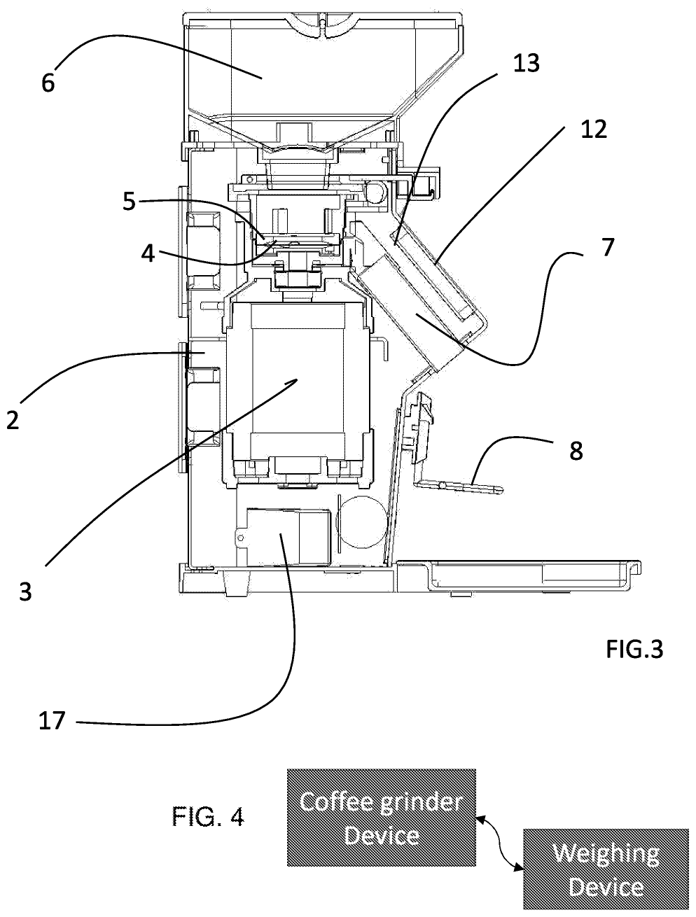

The coffee grinder 1 of the invention, as shown in particular in FIG. 1 to 3, has a general shape of a right prism with a rectangular base 1a, which comprises a support frame 2, on which an electric motor 3 is installed. The motor shaft 3 extends towards the upper part of the coffee grinder to control a group of grinders 4, housed inside a grinding chamber 5. The grinding chamber 5 has, at the top, an opening which puts in communication with a hopper 6 for loading the coffee beans. In the front position, connected laterally to the grinding chamber 5, a channel 7 is then provided for delivering the ground coffee inclined towards a fork 8 for supporting a filter holder. The fork 8 is arranged in an outlet area 9 in a position adjacent to the motor 3. The hopper 6 is closed by a lid 10, also of rectangular shape, whose edge is connected, without interruption, to the lateral surface of the coffee grinder 1. Above the outlet area 9, on the front wall of the coffee grinder 1, a display screen 12 is arranged, preferably of the tactile type, connected to a rear electronic board 13 recessed inside the wall of the coffee grinder 1.

A microcontroller 17 manages the entire operation of the coffee grinder 1 and is operatively connected to the electronic board 13 which manages the touch screen 12, to the power boards which manage the motor 3 and to the control system of the variable position of the grinders 4 and finally to a cooling system and relative thermostat.

The screen 12 has the function of interfacing with the user of the device and being preferably of the tactile type, it allows the user to execute a series of commands and select settings with which the ordinary and extraordinary operation of the coffee grinder is managed. Among the other functions, it is possible to select the mode for adjusting the quantity of coffee (e.g. by adjusting the operating time of the grinders or allowing the device to determine the corrections based on the comparison between the set weight and the weight found by weighing by an external weighing machine).

The fork 8 is adapted for hosting any type of filter holder, in particular a single filter holder, a double filter holder or a filter holder without bottom and lower spouts (also known by the term “naked”); it can also comprise a removable filter holder arm, equipped with retaining means such as magnetic means, so that the removable arm can simply and quickly be removed or re-established in position if necessary.

The system of grinders 4 comprises, in a per se known way, a group of conical and flat grinders; threaded ring nuts with autonomous control system allow to adjust the micrometric distance between said grinders 4 as desired, to modify the granulometric profile of the ground coffee. Finally, a thermostat and a cooling system comprising a motorized fan are arranged in proximity to the grinding chamber 5, again in a manner known per se; said cooling system is used to avoid overheating of the grinders 4 to avoid the transfer of heat to the coffee beans being ground, which could alter the organoleptic principles of the coffee and possibly degrade the performance of the device, possibly shortening its operating life.

In order to reduce as much as possible the stopping of ground coffee residues between the grinders 4 and the filter holder, the grinding chamber 5 is formed so as to be closely adjacent to the outer perimeter of the grinders 4, while the delivering channel 7 is preferably made of a lapped metal material without joints and sharp edges, in order to obtain an optimal fall of the ground coffee powder, once it has entered the channel 7. Again for this purpose, the angle formed by the axis of the channel 7 with respect to the horizontal plane is a sufficiently high angle, preferably between 40° and 60°, for example, an angle of 50°.

Advantageously, said channel 7 can comprise at least one mechanism that prevents the formation of agglomerates in the path of the coffee and/or facilitates the dissolution in the air and powder flow which is articulated in the path between the grinding chamber 5 and the outlet area 9. A possible embodiment of said mechanism comprises at least two plates, adapted for being positioned at partial occlusion of the outlet port between the grinding chamber 5 and the delivery channel 7, and at least one element for regulating the outflow having a shape that develops longitudinally inside said delivery channel 7 along a path with an increasing section in the direction of the end facing the outlet area 9.

In such embodiment, said at least two plates are shaped in such a way as to generate a force consequent to the elasticity of the materials which, opposed to the force generated by the air and powder flow outflowing the grinding chamber, causes a removal of said plates from the rest position by increasing the size of the surface useful for the passage of said powders in a motion which hinders the stationing of the ground coffee on the edges of the orifices.

In the path that the coffee powder performs out of the grinding chamber 5 it is also possible to provide, in at least one embodiment of the invention, the combination with at least one element for regulating the outflow having a conformation that develops longitudinally inside said delivery channel 7 along a path with an increasing section in the direction of the end facing the outlet area 9. In a possible embodiment, said outflow adjustment element is characterized by a geometric figure similar to an elliptical sector, preferably 180° along the major axis, deriving from the intersection of a cylinder, preferably with a circular base, with a plane whose normal is inclined at a predetermined angle with respect to the axis of symmetry of said cylinder and with a second plane whose normal resides in the area resulting from said intersection.

The action of said at least one mechanism, which as just described comprises said at least two plates and said at least one element for regulating the outflow, contributes significantly to the achievement of the purposes of the invention, in particular because avoiding the formation of lumps or agglomerates of coffee powder makes the flow of coffee in the filter more regular and therefore the quantity of ground coffee that ends up in the filter holder is made more linear and predictable. Advantageously, this reduces the formation of agglomerates or generally accumulations of powders along the path from the grinding chamber to the filter holder and even more advantageously it allows the ground coffee to actually end up in the filter holder by equalizing the quantities of powders outflowing from the grinding chamber with the quantities of powders ending in the recipient of destination. In other words, the degree of precision of the grinding is increased, so that the weight remains constant between one dose and the next under the same conditions.

A firmware is installed on the microcontroller 17 which includes a control program and a calibration program, by means of which it is possible to obtain a particularly effective control of the quantity of ground coffee entering the filter holder and its constancy over time. The aforementioned firmware therefore governs, in particular, the general management of the coffee grinder, the processing of a dosage calibration, the driving of the electric motor 3, the operation of the motorized system for adjusting the grinders 4, the detection of the operational configuration of the grinders, the setting of the commands by the user, possibly to a wireless or cable connection for remote control of the device, the control of the temperature of the grinding chamber 5 and to the cooling system of the same.

A wide range of information on the status of the system is also presented by means of said touch screen, and various options for configuring the operating modes and/or updating the operating parameters of the device are also offered. For example, by means of said touch screen it is therefore possible to set the quantity in grams of ground coffee for each dose produced or to perform calibration or cleaning processes. These parameters, through the touch screen 12 are set by the user and stored in the form of a table, in a memory area of the microcontroller 17. In a similar way it is also possible to set on the firmware, for different possible uses or for different mixtures of coffee, corresponding to different distances between the grinders 4, to vary the granulometry of the ground coffee.

The firmware of the microcontroller 17 then incorporates a program for regulating the dose of ground coffee by acting on the operating times of the electric motor and a relative calibration program, to adapt the parameters of the weighing program in order to keep the weight of the single doses as constant as possible, preferably for example in the range of ±0.1 g around the weight value requested by the user. To do this, the microcontroller contains one or more memory areas, preferably non-volatile, which are used to record the characteristic values of each weighing, since said values can include, in addition to the set weight and the weight found and consequently to the difference between said values, a series of information that can be used to reconstruct a history of the operating conditions that can also be used by the operator to guide the choice of the operating mode and/or the most suitable parameters to reach the desired coffee weight in the filter.

This program for controlling the operating period of the electric motor and its calibration was developed after the Applicant, in the course of the studies performed on the grinding operation, was able to detect that the transient start and stop of the grinding have a variability depending on some factors such as the type of coffee and the adjustment of the configuration of the grinders e.g. the spacing between the rotating parts and one or more walls of the grinding chamber, and that all these factors being equal, it is possible to improve the precision in the delivery of ground coffee by acting on the duration of the regime state period of operation of the grinders that is that of the electric motor which is typically operating at a substantially constant speed. Thanks to this discovery, the operating program of the invention was based on the duration of the regime state operating period in combination with a calibration step aimed at identifying the duration and quantity of coffee product in the start and stop step, thus managing to obtain an extraordinarily high consistency of weight in the dose of ground coffee, in the order of ±0.1 g with respect to the desired dose.

The calibration program of the invention is therefore aimed at determining the period of operation of the electric motor at regime state and uses an external weighing device which provides feedback on the amount of powder actually poured into the filter holder. More weighs are expected to be performed in subsequent periods of time, which are not necessarily contiguous. The values obtained for these weighs are in fact stored and used by the firmware in order to assign a correct time value to each subsequent weigh, which varies over time according to the working conditions. In the event of changes in external conditions (e.g. quality of coffee beans, spacing of the grinders to obtain a different granulometry of the powder) that cause the weighed doses to differ by a significant value from the target weight, the firmware suggests performing a calibration step wherein it records the value found for the weight of the doses, it uses it for the calculation of a new period of motor operation.

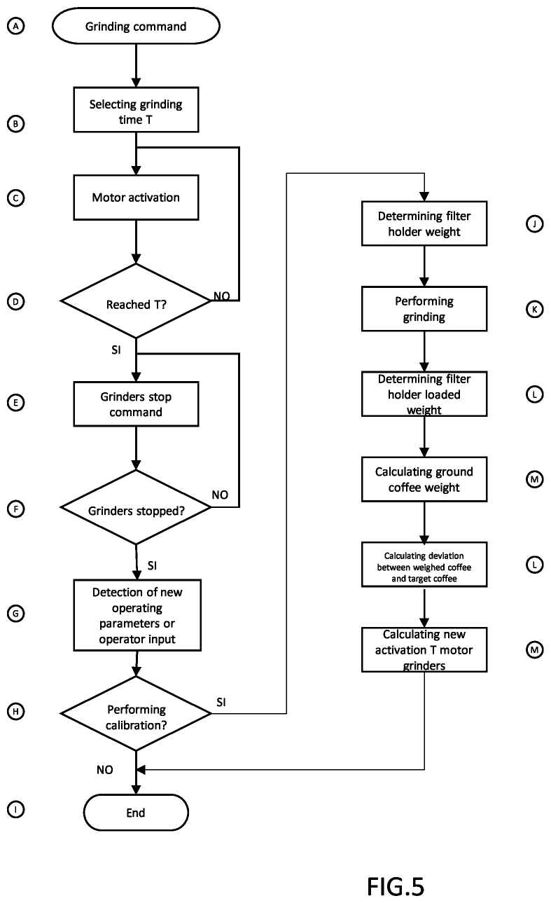

With reference to FIG. 4, a block diagram is generally represented from which it can be seen how, unlike other known configurations, the weighing device is arranged separately from the coffee grinder and therefore does not fall directly within the present invention, as it can be any type of device known to the state of the art, although its use is fundamental for the calibration operations implemented by the electronic control unit of the device object of the invention.

The relationship between the weighing device and the coffee grinder can be limited to the fact that an operator manually performs the weighing and reports what is detected to the coffee grinder, for example through the graphic interface of the same, or said relationship can include, in an executive variant, that the two devices are electrically interconnected in order to exchange information on what is detected during the weighing and, optionally, other information such as the tare of the filter holder (which can be a pre-stored value or measured from time to time) in such a way as to reduce the operations required of the operator which, in a simpler form, only has to translate a loaded filter holder from the coffee grinder to the weighing device and vice versa.

Coming to FIG. 5, it shows a block diagram according to a preferred embodiment of the invention. As found in the left-hand side, upon a grinding command A, i.e., a request to generate a specific dose of coffee powder and deposit it in a filter holder, the firmware selects the period T of activation of the grinders. Such activation period corresponds to the period during which the motor is energized, while such selection can be set according to what is indicated from time to time by the operator may preferably, reflect a temporarily held setting until otherwise specified by the operator. In block C, the grinders are started as a result of the activation of the motor, which will exhibit a start-up transient until it is brought to a regime state condition which will be maintained as long as the elapsed time is equal to the period T, as evident in block D. When this condition is reached, the motor is de-energized (block E) beginning a slowdown step for which (block F) the grinders are expected to stop. In this stopping transient, the crushing of beans in the grinding chamber continues and a certain amount of ground coffee powder flows through the delivery channel up to increasing the amount of coffee in the filter holder.

When the grinders are stopped, any changes in the operating parameters (e.g., different coffee blend or type of thereof, recalibration of the grinders by the operator, different filter holder, sui generis operating anomalies) are detected in the G block and any input from the operator which, for example, changes the machine settings is also read.

Should the need arise to perform a calibration cycle, it will then be necessary to perform a series of steps such that the electronic control unit is made aware of the weight of coffee actually ground during an operating cycle of time period T. As already described, this information can be transferred telematically supported by an electrical or wireless or optical connection between the weighing device and the coffee grinder, or such information can be transferred manually by the operator which, in a feasible and simpler form of execution, reads the weighed value from the weighing device and types it into the coffee grinder via a touch screen or similar input device.

The calibration cycle schematically presented in the right part of FIG. 5 involves determining the amount of coffee ground in a single dose as the difference (block M) between the weight of the loaded portafilter (block L) and the weight of the empty portafilter (block J).

In an executive variant, the empty weight of the filter holder is pre-stored in a table in the memory of the electronic control unit, which can simply calculate the net weight without steps J, K, L. being performed, and the selection of the filter holder is done by the operator when a filter holder is first used. In a further executive variant, the filter holder is automatically recognized by the control unit by means of one or more sensors of a known type, such as an optical reader that recognizes a tag on the filter holder itself.

Once, during calibration operations, the control unit has detected the weight of coffee produced and measured by the weigher, it proceeds to calculate the deviation (block L) and to recalculate the period of energization of the electric motor that moves the grinders.

In a preferred executive variant, the motor operates, in the regime state step, at a constant speed, and the mass flow rate, i.e., the amount of coffee produced in the unit of time, is considered to be constant throughout the entire period of constant speed operation of the motor in said regime state step. The Applicant has verified that this is generally true and even more so if the coffee grinder is equipped with systems that contrast the formation of lumps of powder in the delivery channels and/or at the outlet port of the grinding chamber that faces said channel. In the context wherein the motor operates at a constant speed, an executive form of the invention involves varying the time duration of the regime state step in proportion to the difference between the target quantity (Pf) and the measured quantity (Pr) of coffee produced in the whole of start-up, regime state, and stop steps.

In a further variant, the firmware implements a weighted calibration algorithm which involves processing weight values taken from a number (n) of subsequent weighing, for example, three. Such weighing must fall within an appropriate range, for example, having a tolerance of ±0.4 grams from the set reference value, such as that of 7 grams for the single dose, otherwise they are discarded by the weighted calibration process as being evaluated as abnormal weighing and therefore not sufficiently representative to be considered in a useful way for the calibration program. Furthermore, to be taken into account, for the purpose of determining a variation in the grinders activation time T, subsequent weighing must all be either greater than or less than the reference value, thus indicating a trend of weight change toward a defined direction. In other words, if in a group of three subsequent weighing one weighing shows a variation in the opposite direction to that of the other two values in the sequence, this group of weighing is not considered for calculating a new T value.

In a further variant of the invention, it is also provided a transient calibration program aimed at determining the amount of coffee powder produced during said start and/or stop steps, which transient calibration program includes the following operational steps:
informing an operator of the coffee grinder to perform empty weighing of the filter holder;
acquiring the value of said empty weighing of the filter holder;
performing a start and stop step sequentially and, if necessary, repeating this sequence one or more times;
informing a coffee grinder operator to perform a weighing by the filter holder once the grinding of a dose has been completed;
acquiring the value of said weighing by the filter holder;
determining the weight of the ground coffee dose by difference or by averaged difference of the previously acquired values;
resetting the amount of ground coffee associated with said start and stop steps.

Advantageously, the execution of these method steps allows to determine the amount of coffee that is produced exclusively in the start-up and stop steps, i.e., to the exclusion of the regime state step having time duration T. In this way, it is possible to further refine the calculation and thus the achievement of the desired amount of coffee Pf. In fact, by separating the amount of coffee produced in the start-up and stop transients from the total amount of coffee produced, it is possible to determine with further precision the mass flow rate of coffee flowing out of the grinding chamber when the grinders are operating at regime state, thus associating a precise and constant value of the powder generated per unit time. Having noted this value, it is immediate to recalculate the optimal period T by simply relating this flow rate value (e.g., expressed in grams/second) to the deviation between Pf and Pr (in grams) to define the corrections (in seconds) to the period T of operation of the electric motor.

It is clear from the above description that the coffee grinder according to the present invention has fully achieved its intended purposes. In fact, the weighing program used by the coffee grinder provides for detecting only the weight of the ground coffee that has actually reached the filter holder, thus avoiding all the drawbacks associated with previous types of measurement based on the operating time of the grinders. Grinding is stopped when the weight thus detected differs from the desired final value by a value Δ, which corresponds to the weight of coffee ground during the grinders stop transient. The weight value Δ has the characteristic of being essentially constant, under the same working conditions, and thus can be easily determined experimentally and constantly optimized as working conditions change by means of the calibration program of the invention. Such a calibration program uses, as seen above, a particularly simple algorithm, which can thus be handled effectively by inexpensive electronics.

Thus, the coffee grinder of the present invention offers significant advantages over grinders of the known type, both in relation to the high constancy of the dosage weight of ground coffee, in relation to the lower cost of manufacture, and finally in relation to the great ease and convenience of use. Indeed, the constant calibration program used in the invention coffee grinder does not require any intervention by the operator, which has only to set, on a one-time basis, the weight value of the desired doses of ground coffee, for each individual type of filter holder used.

It is to be understood, however, that the invention is not to be considered limited to the particular provisions illustrated above, which are merely illustrative forms of execution of it, but that several variations are possible, all within the field of a skilled person in the art, without thereby departing from the scope of protection of the invention itself, which is solely defined by the claims that follow.

The invention claimed is:

1. A coffee grinder configured to control a quantity of coffee dispensed for each dose of ground coffee, comprising:
an electric motor (3);
a group of grinders (4) driven by said electric motor (3) and housed inside a grinding chamber (5);
a hopper (6) for feeding coffee beans to be ground towards said grinding chamber (5);
a delivery channel (7) for delivering the ground coffee beans towards a support fork (8) configured to hold a filter holder to be loaded with the ground coffee beans; and
a microprocessor (17) that controls an operation of the electric motor (3) to obtain a desired target quantity (Pf) of ground coffee inside said filter holder, said microprocessor (17) containing a control firmware configured as a coffee grinder management software encoding instructions that make the said microprocessor and peripherals thereof adapted to carry out the following operating steps:
a) determining an activation time period of the electric motor necessary for an activation of the said group of grinders to produce a target quantity of the ground coffee;
b) activating the electric motor (3) and causing a grinding of the coffee beans by the said group of grinders (4);
c) commanding a stop of the electric motor (3) after a known period equal to the determined activation time period;
wherein a determination of the activation period of the electric motor comprises an optional calibration step where the activation period is varied to reduce a value of a difference in weight of the ground coffee, calculated between the desired target quantity (Pf) and a dose actually dispensed in the filter holder (Pr), under a predetermined threshold, the coffee grinder being configured to operate alternatively between:
a first mode for regulating the activation period of the electric motor, wherein the calibration step takes place by manually varying, by an operator, the activation period of the electric motor; or
a second mode for regulating the activation period of the electric motor, wherein said calibration step takes place automatically according to a comparison between a desired weight of the ground coffee (Pf) and the weight of the ground coffee actually dispensed in the filter holder (Pr) and measured with a weighing device physically separated from the coffee grinder.

2. The coffee grinder according to the claim 1, wherein the microprocessor is programmed to carry out the calibration step, which is configured to implement a calibration sequence comprising the steps of:
d) detecting, with the weighing device, the actually dispensed dose (Pr) of the ground coffee that, through said dispensing channel (7), has reached the filter holder resting on said fork (8);
e) compare the target quantity measured as target weight (Pf) with the measured weight of the actually dispensed dose measured as a dispensed weight (Pr); and
f) evaluating and possibly varying at least one operating parameter of the electric motor as a function of a difference between said target weight (Pf) and said dispensed weight (Pr);
where said calibration sequence can be activated by the operator of the coffee grinder on spontaneous initiative and/or on indications of the calibration sequence executed by the microprocessor via a man-machine interface.

3. The coffee grinder according to claim 1, wherein said weighing device is connected to said microprocessor through a physical communication channel and exchanges one or two-way information data with said microprocessor.

4. The coffee grinder according to claim 1, wherein said activation period of the electric motor is determined according to the following operating conditions of said electric motor:
a starting step, comprising a transition of said electric motor from a rest condition until reaching a known condition of rotation speed;
a regimen state step, comprising an operation in a known condition of rotation speed; and
a stopping step, comprising a transition of said electric motor from the known condition of known speed rotation speed to a condition of rest;
wherein to each of the said starting and stopping steps there are associated a known time duration and a known quantity of dispensed ground coffee; and
wherein at least one operating parameter of the electric motor when operating at regimen is selected so that a detected quantity of the ground coffee dispensed (Pr) into the filter holder from a beginning of said starting step to an end of said stopping step is substantially equal to the an initially selected target quantity.

5. The coffee grinder according to claim 4, wherein a time period and/or said known quantity of the ground coffee in the starting step are selected to be of equal value to a corresponding time period and/or a corresponding quantity of the ground coffee in the stopping step.

6. The coffee grinder according to claim 4, wherein during said regimen state step the group of grinders operates at substantially constant speed for at least part of a time period of the said regimen state step.

7. The coffee grinder according to claim 4, wherein a time period of the regimen state step is varied proportionally to a difference between the target quantity (Pf) and the dispensed quantity (Pr) of the coffee produced in the starting, regimen and stopping steps.

8. The coffee grinder according to claim 4, further comprising at least one mechanism for adjusting a configuration of said group of grinders so as to vary a granulometry of the ground coffee, a position sensor and/or a status of said group of grinders being associated to said mechanism, wherein the microprocessor acquires signals coming from said position sensor and uses said signals in combination with the calibration sequence to generate functional operational combinations comprising a combination of specific position of the grinders and a specific duration of activation of the electric motor.

9. The coffee-grinder according to claim 8, wherein the microprocessor is further programmed to execute one or more of the following steps:
detecting a change of configuration and/or a configuration of said group of grinders;
setting predetermined values of time periods of the said starting, regimen state, and stopping steps;
determining time periods of the said starting, regimen state, and stopping steps.

10. The coffee grinder according to claim 4, wherein the microprocessor (17) is further programmed to provide a weighted calibration program, which comprises the following steps:
storing a predetermined number (n) of successive weighs;
calculating an average weight value on said predetermined number (n) of successive weighs;
determining an average difference between said average weight value and a value of the target quantity (Pf) of a desired weight; and
modifying at least one operating parameter of the electric motor in the regimen state as a function of said average difference.

11. The coffee grinder according to claim 10, wherein the storing of the predetermined number of successive weighs occurs only when all the successive weighs have a same sign of variation of a detected weight with respect to the value the target quantity (Pf).

12. The coffee grinder according to claim 11, wherein the successive weighs having a value in excess of a predetermined reference value are not stored.

13. The coffee grinder according to claim 1, further comprising an element for regulating an outflow of coffee powder having a specific conformation and elasticity so as to prevent a formation of lumps in the ground coffee and an accumulation of the coffee powder ground along the delivery channel (7).

14. The coffee grinder according to claim 1, further comprising means for manual or automated removal of residues and/or accumulations of coffee powder thickened inside said grinding chamber and/or on surfaces of the organs involved in pulverization and/or in conveyance of the ground coffee into said delivery channel.

15. A kit for grinding coffee beans comprising:
a coffee grinder according to claim 1; and
a weighing device for weighing the coffee produced by said coffee grinder, said weighing device and said coffee grinder being configured to accommodate a container or the filter holder for containing the ground coffee.
